(19) United States
(12) Patent Application Publication
(10) Pub. No.: US 2018/0347100 A1
(43) Pub. Date: Dec. 6, 2018

(54) COMMERCIAL LAUNDRY WASTE WATER TREATMENT SYSTEM

(71) Applicant: WATER RECOVERY SYSTEMS, LLC, Kenner, LA (US)

(72) Inventors: Russell H. POY, New Orleans, LA (US); Kyle Anthony WOLFF, London (GB); Sharon Monica MAK, New Orleans, LA (US)

(73) Assignee: WATER RECOVERY SYSTEMS, LLC, Kenner, LA (US)

(21) Appl. No.: 15/997,390

(22) Filed: Jun. 4, 2018

Related U.S. Application Data
(60) Provisional application No. 62/514,834, filed on Jun. 3, 2017.
(60) Provisional application No. 62/514,828, filed on Jun. 3, 2017.

(51) Int. Cl. D06F 39/10; D06F 31/00; D06F 39/08; C02F 1/00; C02F 1/68

(52) U.S. Cl. CPC D06F 39/10; D06F 31/005; C02F 1/685; C02F 1/006; D06F 39/085

(57) ABSTRACT

The present invention provides a method of treating a commercial or industrial laundry wastewater stream. The method and apparatus treats a commercial laundry waste stream from a commercial washing machine or machines wherein the waste includes total suspended solids, chemical oxygen demand, biological oxygen demand, turbidity, and bacteria. The waste stream is transmitted to a first treatment unit that has a membrane filter that filters particles of between about 6 and 40 nanometers. At the first treatment unit, the waste stream is separated into a permeate stream and a retentate component. The retentate component is transmitted to a second treatment unit that filters particles of between about 3 and 10 nanometers. The permeate stream is then transmitted to a permeate holding vessel after treatment in the second treatment unit. The retentate component is placed in a mixing vessel where it is mixed with a polymer to form a solid waste.

### CROSS-REFERENCE TO RELATED APPLICATIONS

This application claims benefit of U.S. Provisional Patent Application Ser. No. 62/514,834, filed 3 Jun. 2017; and U.S. Provisional Patent Application Ser. No. 62/514,828, filed 3 Jun. 2017, each of which is hereby incorporated herein by reference.

Priority of U.S. Provisional Patent Application Ser. No. 62/514,834, filed 3 Jun. 2017; and U.S. Provisional Patent Application Ser. No. 62/514,828, filed 3 Jun. 2017, each of which is hereby incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to an improved method and apparatus for treating laundry (e.g., commercial or industrial or other) that features first and second treatment vessels that generate permeate and retentate streams, wherein the retentate stream is combined with a polymer and solidified for disposal.

### 2. General Background of the Invention

Textile washing performed in commercial laundries typically consumes between about 2.5 to 25+ liters of waste water for each kilogram of articles or goods to be washed. Current technologies using ceramic filters and reverse osmosis have been used to treat the waste water to be reused in the washing process. However, these prior art systems produce highly concentrated (BOD (Biological Oxygen Demand), COD (Chemical Oxygen Demand), TDS (Total Dissolved Solids), and TSS (Total Suspended Solids)) waste referred to as retentate. The result is a significant quantity of retentate typically about 0.5 to 5 L/Kg. In certain applications the retentate can be twice as high. As an example, a laundry washing 20 million kilograms of linen per year would generate between 10 to 100 million liters of retentate. This retentate must be treated by a municipal potable water treatment facility.

U.S. Provisional Patent Application Ser. No. 62/514,828, filed 3 Jun. 2017, is hereby incorporated herein by reference. U.S. Provisional Patent Application Ser. No. 62/514,828 on page 9, lines 7-8, states that the wall of each hollow ceramic fiber can be between about 2 and 4 mm thick. The thickness of the wall of each hollow ceramic fiber can preferably be between about 1 and 4 mm thick. U.S. Provisional Patent Application Ser. No. 62/514,828 on page 9, line 31, states that each hollow ceramic fiber has a polymeric coating on the tube wall. Preferably, each hollow ceramic fiber can have a polymeric, metal oxide, or graphene oxide coating on the tube wall, wherein the metal oxide can be for example an aluminium oxide, zirconia oxide or titanium oxide.

The following table lists patents (each hereby incorporated by reference) directed to commercial washing systems such as tunnel washing machines.

TABLE 1

| | | Issue Date |
|---|---|---|
| Patent No. | Title | MM-DD-YYYY |
| 8,166,670 | CLOTHES DRYER APPARATUS WITH | May 1, 2012 |
| | IMPROVED LINT REMOVAL SYSTEM | |
| 8,689,463 | CLOTHES DRYER APPARATUS WITH | Apr. 8, 2014 |
| | IMPROVED LINT REMOVAL SYSTEM | |
| 7,971,302 | INTEGRATED CONTINUOUS BATCH | Jul. 5, 2011 |
| | TUNNEL WASHER | |
| 7,611,627 | MEMBRANE MODULE S WELL AS A | Nov. 3, 2009 |
| | METHOD FOR MAKING A | |
| | MEMBRANE MODULE | |
| 8,370,981 | INTEGRATED CONTINUOUS BATCH | Feb. 12, 2013 |
| | TUNNEL WASHER | |
| 8,336,144 | CONTINUOUS BATCH TUNNEL | Dec. 25, 2012 |
| | WASHER AND METHOD | |
| 8,365,435 | Laundry press apparatus and method | Feb. 05, 2013 |
| 9,127,389 | CONTINUOUS BATCH TUNNEL | Sep. 8, 2015 |
| | WASHER AND METHOD | |
| 9,580,854 | CONTINUOUS BATCH TUNNEL | Feb. 28, 2017 |
| | WASHER AND METHOD | |
| 9,322,128 | LAUNDRY PRESS APPARATUS AND | Apr. 26, 2016 |
| | METHOD | |
| 9,200,398 | CONTINUOUS BATCH TUNNEL | Dec. 01, 2015 |
| | WASHER AND METHOD | |
| 5,707,584 | METHOD FOR THE PRODUCTION | Jan. 13, 1998 |
| | OF CERAMIC HOLLOW FIBRES | |

### BRIEF SUMMARY OF THE INVENTION

A laundry washing 20 million kilograms of linen per year generates between 10 to 100 million liters of retentate. This retentate must be treated by a municipal potable water treatment facility.

Using a combination of hollow fiber ceramic filters, the retentate is reduced to 0.1 to 0.5 liters per kilogram. In the example above, the 20M kilos washed would only produce 800,000 liters of annual retentate. This invention further treats the retentate with environmentally friendly polymers to make the retentate into a disposable solid. Thus, no discharge is produced to the municipal potable water treatment facility.

The present invention provides a method of treating a commercial or industrial laundry wastewater stream. The method and apparatus treats a commercial laundry waste stream from a commercial washing machine or machines wherein the waste includes total suspended solids, chemical oxygen demand, biological oxygen demand, turbidity, and bacteria. The waste stream is preferably transmitted to a first treatment unit that has a membrane filter that filters particles of between about 6 and 40 nanometers. At the first treatment unit, the waste stream is preferably separated into a permeate stream and a retentate component. The permeate stream or “permeate” is the water that has been treated by the membrane. The retentate component (that which is retained by the filter) is transmitted to a second treatment unit that filters particles of between about 3 and 10 nanometers. The permeate stream from this second treatment unit is transmitted to a permeate holding vessel after treatment in the second treatment unit. The retentate component is placed in a mixing vessel where it is mixed with a polymer to form a solid waste.

In one embodiment, a second permeate flow stream can discharge from the second treatment vessel/unit.

In one embodiment, the retentate component can be reduced to between about 0.1 and 0.5 liters per kilogram.

In one embodiment, the filtered permeate stream can have a chemical biological oxygen demand that was reduced by about ninety percent (90%).

In one embodiment, the filtered permeate stream can have total suspended solids that was reduced by about ninety-six percent (96%).

In one embodiment, the filtered permeate stream can have turbidity that was reduced by about ninety-eight percent (98%).

In one embodiment, the filtered permeate stream can have a non-detectable level of E-Coli.

The present invention includes a method of treating a commercial laundry waste stream. The commercial laundry waste stream can be discharged from one or more commercial washing machines, wherein the waste stream can include one or more of suspended solids, dissolved solids, and CBOD (chemical biological oxygen demand). The waste stream can be transmitted to a first treatment unit that can have a membrane filter that filters particles of between about 20 and 200 nanometers (nm). The waste stream can be separated into a permeate stream and a retentate component, wherein the retentate component can be smaller than the permeate component. The retentate component can be transmitted to a second treatment unit that preferably filters particles of between about three and twenty (3-20) nanometers. The permeate stream can be transmitted to a permeate holding vessel. The retentate component can be mixed in a mixing vessel with a polymer, or polymer blend to preferably form a solid waste.

In one embodiment, the filtered permeate stream can have a chemical biological oxygen demand (BOD) that is preferably reduced by over seventy percent (70%).

In one embodiment, the filtered permeate stream can have total suspended solids (TSS) that was preferably reduced by over seventy percent (70%).

In one embodiment, the filtered permeate stream can have turbidity that was preferably reduced by over seventy percent (70%).

In one embodiment, one of the treatment units can include a bundle of at least 200 hollow fiber ceramic membranes.

In one embodiment, the polymer or polymer blend can be composed of mixtures of superabsorbent polyacylate polymers with inorganic clays.

In one embodiment, the polymer or polymer blend can be bentonite clay.

In one embodiment, the superabsorbent polyacrylate—clay mixtures can contain about 30% to 80% superabsorbent polyacrylate.

In one embodiment, the retentate component includes highly concentrated biological oxygen demand (B.O.D.) of between about 1938 and 13,900 mg/L, Chemical oxygen demand (COD) of between about 2,805 and 17,595 mg/L, total dissolved solids (T.D.S.) of between about 3250-4550 mg/L and Total suspended solids (T.S.S.) of between about 450-3200 mg/L.

The present invention includes a method of treating a commercial laundry waste stream. The commercial laundry waste stream can be discharged from a commercial washing machine, wherein the waste stream includes one or more of suspended solids, dissolved solids, and CBOD (chemical biological oxygen demand). The waste treatment unit can be transmitted wherein the waste stream is preferably treated with a filter to remove particles of between about twenty and two hundred nonometers. The waste stream can be separated into a permeate stream and a retentate component. The retentate component can be transmitted to a second treatment unit that removes particles of a second size that is preferably between about three and twenty (3-20) nanometers. The permeate stream can be transmitted to a permeate holding vessel. The retentate component can be solidified by combining the retentate component with a polymer.

In one embodiment, each hollow fiber ceramic filter can be tubular, having a central longitudinal bore.

In one embodiment, the permeate stream can be comprised of non-detectable levels of E-Coli and turbidity of less than one (1) nephelometric turbidity units (N.T.U.).

In one embodiment, there are preferably multiple modules, each module can have a bundle of hollow fiber ceramic membrane.

In one embodiment, both of the treatment units can includes a bundle of at least 200 hollow fiber ceramic membranes.

In one embodiment, there can be a plurality of said bundles.

In one embodiment, at least some of the bundles can be vertically stacked one upon the other and wherein the flow stream preferably flows from a lower of the bundles to an upper of the bundles.

In one embodiment, the ceramic membranes can include multiple pairs of risers, each of the pair of risers can be connected with one or more elbow fittings.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a schematic diagram of a preferred embodiment of the apparatus of the present invention;

FIG. 2 is a perspective view of a preferred embodiment of the apparatus of the present invention showing a membrane filtration treatment unit;

FIG. 3 is a perspective view of a preferred embodiment of the apparatus of the present invention showing a membrane filtration treatment unit;

FIGS. 4-6 are schematic diagrams showing operation of a module of hollow fiber ceramic membranes that are used in the treatment devices of the present invention;

FIG. 7 is a fragmentary perspective view of a preferred embodiment of the apparatus of the present invention;

FIG. 8 is a fragmentary end view of a preferred embodiment of the apparatus of the present invention;

FIG. 9 is a fragmentary perspective view of a preferred embodiment of the apparatus of the present invention;

FIG. 10 is a fragmentary perspective view of a preferred embodiment of the apparatus of the present invention;

FIG. 11 is a schematic diagram of a method and apparatus of the present invention; and

FIG. 12 is a schematic diagram of a method and apparatus of the present invention showing pumping to the left side conduit.

### DETAILED DESCRIPTION OF THE INVENTION

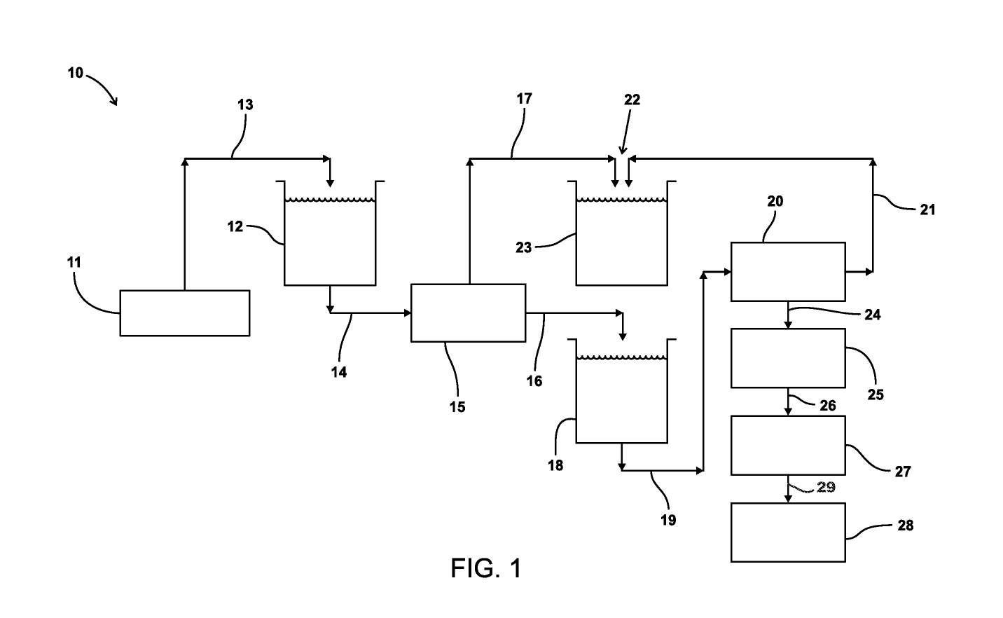

FIG. 1 is a schematic diagram showing a method and apparatus of the present invention, designated generally by the numeral 10. In FIG. 1, laundry waste water treatment system provides a feed tank 12 that preferably receives flow of waste water via flow line 13 from a washing machine (or machines) 11 (e.g., commercial washer, tunnel washer). Such commercial washing machines typically generate between about 2.5-25 liters of wastewater for each kilogram of goods being washed. As an example, if twenty percent (20%) of the wastewater stream becomes retentate in line 16, a laundry washing 20 million kilograms of goods (fabric articles or linens) would generate between about ten million and one hundred million liters of retentate. Such retentate typically has high biological oxygen demand (BOD), chemical oxygen demand (COD), total dissolved solids (TDS), and total suspended solids (TSS). Feed tank 12 preferably transmits this wastewater via flow line 14 to a first treatment module 15. Module 15 preferably filters with a membrane to filter and retain particles that are between about twenty (20) and two hundred (200) nanometers (nm). Such membrane filters are commercially available. Flow in line 14 can be an average of about 100 gallons or 375 liters per minute as an example.

Preferably, two (2) flow lines receive discharge from treatment unit 15. These flow lines include retentate flow line 16 and permeate flow line 17. Line 16 preferably transmits retentate to retentate tank 18. Flow line 19 preferably transmits retentate from tank 18 to retentate treatment module 20. Treatment module 20 preferably uses a membrane (e.g., ceramic membrane) to filter particles between about three (3) and twenty (20) nanometers (nm), removing those particles from the material flowing to unit 20 via line 19. The discharge from retentate treatment module 20 preferably includes flow line 21 and flow line 24. Lines 21 and 24 include permeate flow line 21 and retentate flow line 24. Flow line 21 can combine with permeate flow line 17 at tee fitting 22. Flow lines 17, 21 discharge into permeate tank 23.

Flow line 24 preferably discharges retentate to mixing unit 25. In mixing unit 25, retentate from flow line 24 can be treated with a polymer that will combine with the retentate to generate a solid waste 27. The polymer can be a super-absorbent sodium polyacrylate (C₃H₃NaO₂)n or potassium polyacrylate [—CH₂—CH(CO₂K)—]n polymer. A polymer blend applied can compose of more than 99 percent polyacrylate polymers or a blend with chemically inert and natural occurring inorganic additives such as clay (smectite clay minerals) and zeolites. Upon contact with water, the sodium ions within the polymer disassociates from the carboxylate ions to create higher osmotic pressure within the gel to absorb the free water. The hydrophilic polymer or polymer blend has high absorbency rate of more than 100 of its weight in aqueous fluids including the retentate component. The polymer blend with inorganic clay or zeolites can provide adsorption of organic matters attributed by the on-exchange properties and large surface area of the inorganic clay minerals. Free liquid containing high suspended solids, dissolved solids, organic matter, oils and greases can be immobilized by way of absorption and/or adsorption to create solid wastes. The polymer or polymer blend prevents release of liquids when compressed, hence, converting liquid waste to a stable solidified form for landfill disposal. Such polymers are commercially available (e.g., from Metaflo Technologies of Toronto, Canada and Dover, Del. (www.metaflotech.com/ca)). Arrow 26 represents a discharge of solids or solid waste 27 from mixing unit 25. Solids or solid waste 27 can be transported to a suitable disposal facility 28, as indicated by arrow 29.

The polymer or polymer blend can be commercially available in fine powder form. Such a polymer can be of a white/beige color; bulk density ranging from about 0.4 to 1.11 grams per cubic centimeter and particle size less than about 400 microns. The polymer or polymer blend application rate can be in the range of about 1 to 10 percent (wt/wt) based on a weight percentage, and preferably in the range of about 1 to 4 percent (wt/wt) being about 1 to 4 kg per cubic meter retentate. The application rate can vary according to total dissolved solids content of retentate and polymer blends to generate stable solids. The polymer or polymer blend can be added via a controlled batch dosing system into a mixing vessel to increase dispersion and reduce contact time. Alternatively, the polymer or polymer blend dosing and mixing with retentate can also be undertaken via continuous retentate flow using a commercially available dosing and mixing apparatus such as Metaflo LMS supplied by Metaflo Technologies, Inc. (e.g., see U.S. Pat. No. 7,901,571). The solid waste formed would be disposed according to local landfill and regulatory requirements.

Using a method and apparatus of the present invention, test results on a waste stream that was treated show reductions in several parameters. The method and apparatus of the present invention reduced chemical biological oxygen demand (CBOD) by about ninety percent (90%) when treating a commercial laundry wastewater stream. The method and apparatus of the present invention reduced total suspended solids (TSS) by about ninety-six percent (96%) when treating a commercial laundry wastewater stream. Turbidity for the treated commercial laundry wastewater stream was reduced about ninety-eight percent (98%). Treatment of a commercial laundry wastewater stream using the method and apparatus of the present invention filtered E-Coli bacterial to non-detectable levels.

The following are examples of clay-polymer composite mixtures of the present invention and effluent characteristics.

### Inorganic Clay Additive Used in “Polymer Blend”:

a. Polymer blends can be composed of mixtures of superabsorbent polyacylate polymers with inorganic clays such as bentonite clay (also known as montmorillonite clay) classified under the smectite group.

b. Bentonite clay (such as sodium bentonite) has excellent liquid sorption capacity and ion-exchange properties due to the exchangeable interlayers of cation (sodium in the case of sodium bentonite). These interlayers bind the aqueous retentate, resulting in swelling of the clay structure.

c. The polymer blend can be formulated to the retentate water quality characteristics such as total dissolved solids or conductivity.

d. Example superabsorbent polyacrylate—clay mixtures can contain about 30% to 80% superabsorbent polyacrylate.

e. Such polymer blends may reduce application cost.

### Retentate Characteristics:

Retentate is generated from Treatment Module No. 2 (20, 145) by filtering the reject produced Treatment Module No. 1 (15, 144).

Example of raw wastewater and Treatment Module No. 2 (20, 145) Retentate characteristics:

| | Raw | Retentate |
|---|---|---|
| | Wastewater | From treatment |
| | from washers | module no. 2 |
| Oils and greases, mg/L | 50-300 | 185-590 |
| (O&G) | | |
| Total dissolved solids, mg/L | 2500-3500 | 3250-4550 |
| (TDS) | | |
| Total suspended solids, mg/L | 170-1200 | 450-3200 |
| (TSS) | | |
| Biological oxygen demand | 600-4300 | 1938-13,900 |
| (BOD) mg/L | | |
| Chemical oxygen demand | 1,100-6,900 | 2,805-17,595 |
| (COD) mg/L | | |

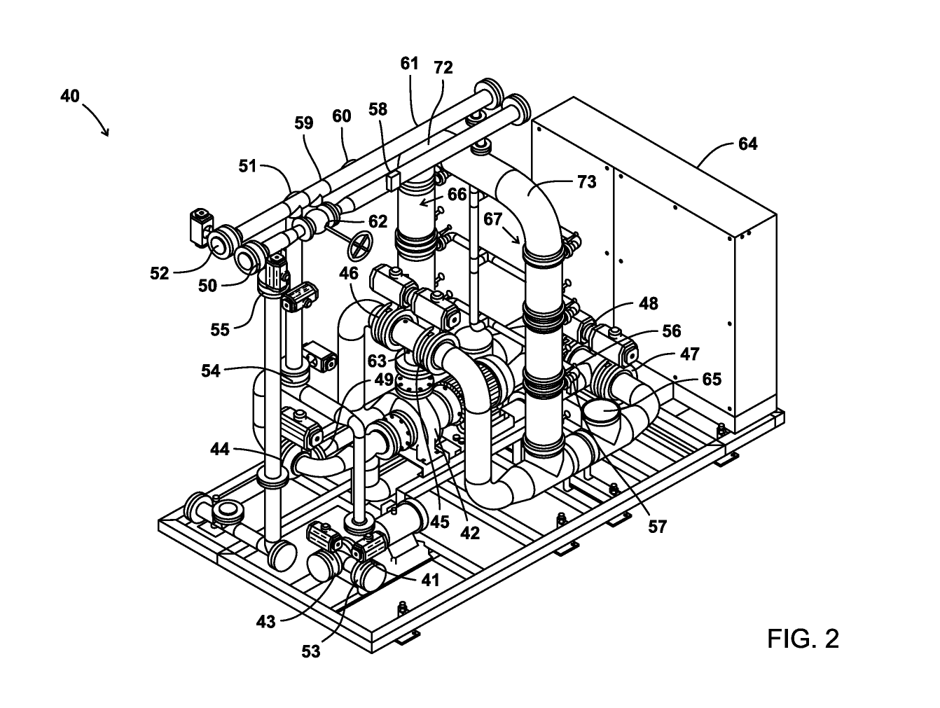

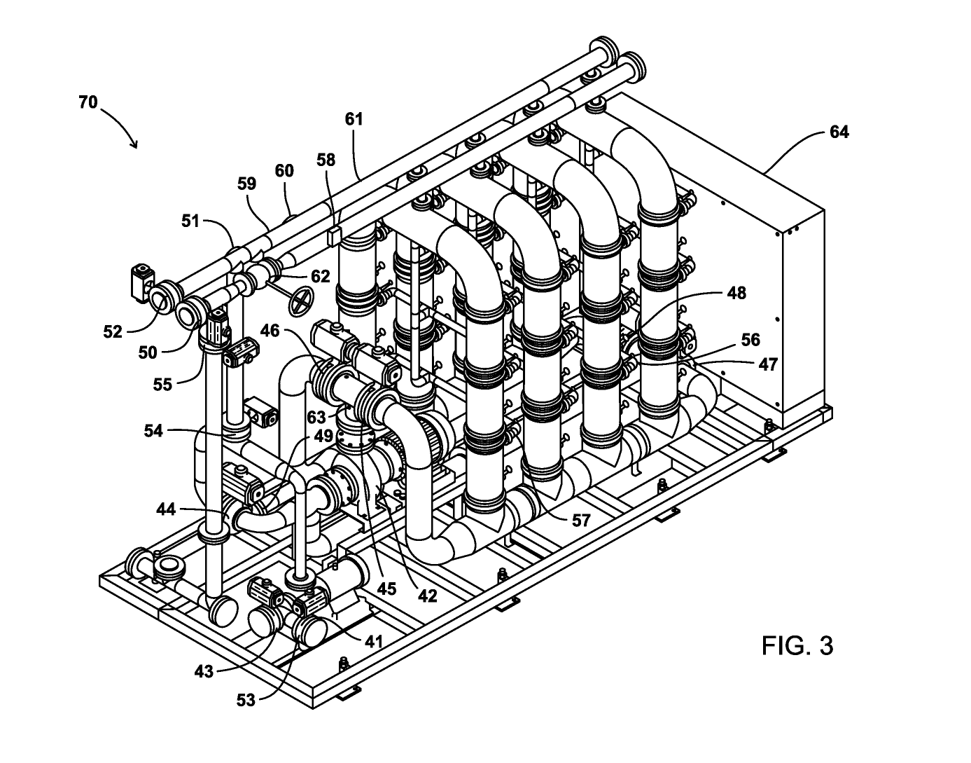

FIGS. 2 and 3 show perspective views of membrane filtration treatment units used for commercial and industrial applications. FIG. 2 shows a filtration unit 40 preferably having six (6) hollow fiber ceramic filters or modules. FIG. 3 shows a filtration device or skid 70 preferably having twenty-four (24) hollow fiber ceramic filters or modules. Units 40 or 70 can be used at the second treatment unit or module designated as 20 in FIG. 1.

The filtration device/skid 40, 70 in FIGS. 2, 3 have a feed pump 41, a recirculation pump 42, valves (e.g., butterfly) 43, 44, 45, 46, 47, 48, 49, 50, 51, 52, 53, 54, 55, pressure transmitters 56, 61, 63, flow meters 57, 58, 60, a turbidity meter 59, a globe valve 62, a future filter expansion 65, and a control panel 64.

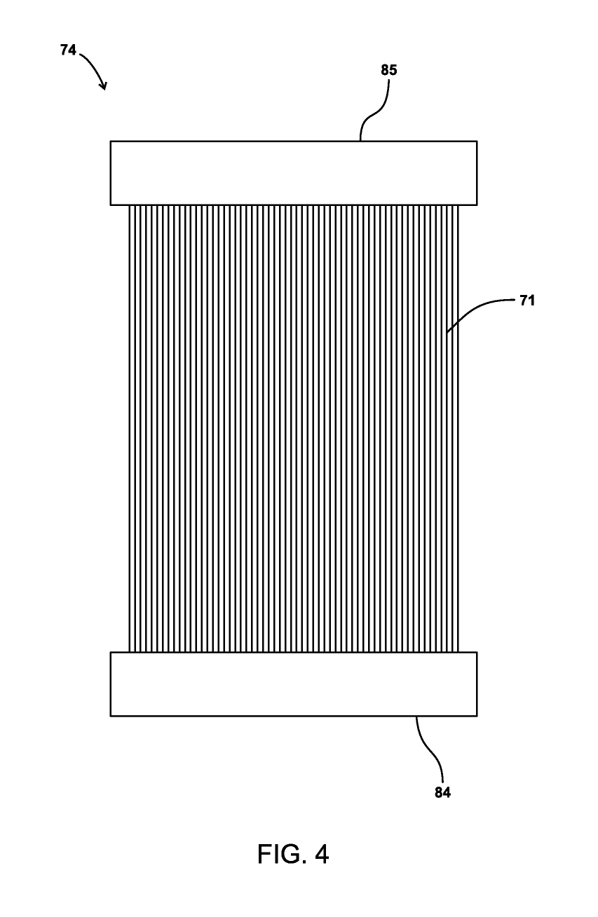

In FIG. 2, three sections of pipe define three (3) stacked filters or modules 66. A pump 41 can pump waste water up vertically through the stacked filters or modules 66 and then travel via elbow fittings 72, 73 to another set of three (3) stacked filters or modules 67. Flow thus travels through a total of six (6) filters or modules 66, 67 in FIG. 2. The filters or modules 66, 67 can be made of fiber ceramic material such as hollow ceramic fiber membranes as seen in FIGS. 4-10.

FIG. 3 shows a similar filtration device/skid as seen in FIG. 2, except that the filtration device/skid 70 of FIG. 3 shows four (4) sets of filtration units, each set including six (6) stacked filters or modules 66, 67, similar to FIG. 2. Filtration device/skid 70 preferably has a total of twenty-four (24) filters or modules 66, 67. Wastewater reaches skid 70 (treatment unit 15) via line 14. Flow is preferably routed to each of the six (6) stacked modules 66, 67. Each module 66, 67 has a bundle 74 of hollow fiber ceramic membranes 71 as seen in FIGS. 4-6 and 7-10. During filtration, each module 66, 67 can be a bundle 74 of such hollow fiber ceramic membranes 71 (e.g., 200-1500 membranes) bound together to form a cylindrical shape and preferably held together with end caps 84, 85. During filtration, each individual membrane 71 filters water from an inside channel 75 to the outside surface 76 wherein filtered water is collected outside the membrane walls 77 all of the bundles 74. The modules or bundles 74 are preferably contained in a stainless steel pipe section or spool piece 66, 67. In the process, the filtration device/skid 40, 70 preferably removes waste material and it creates clean water.

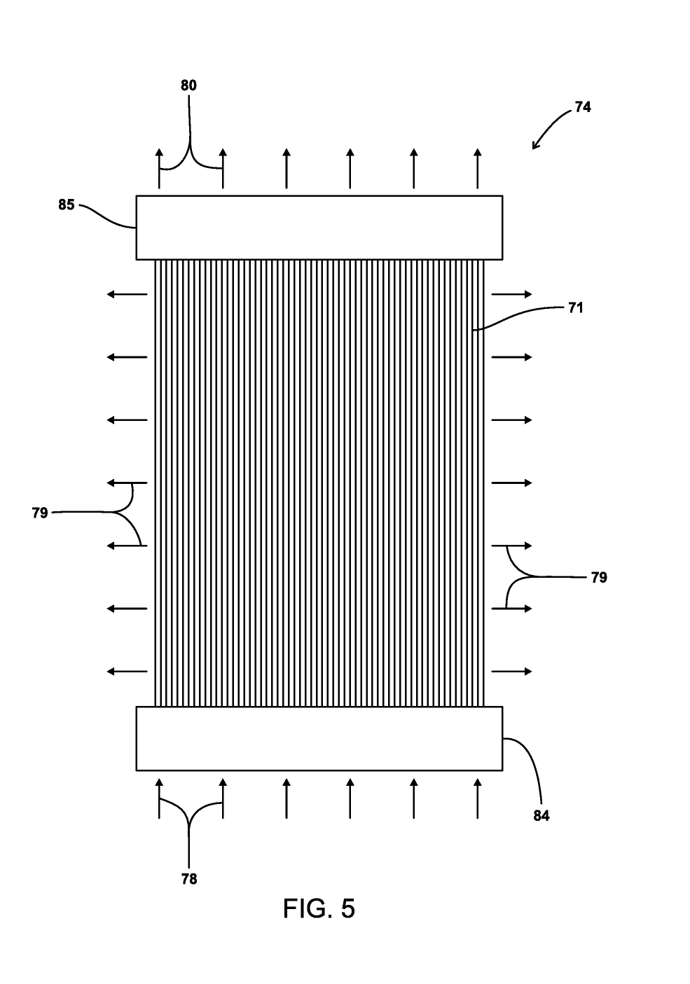

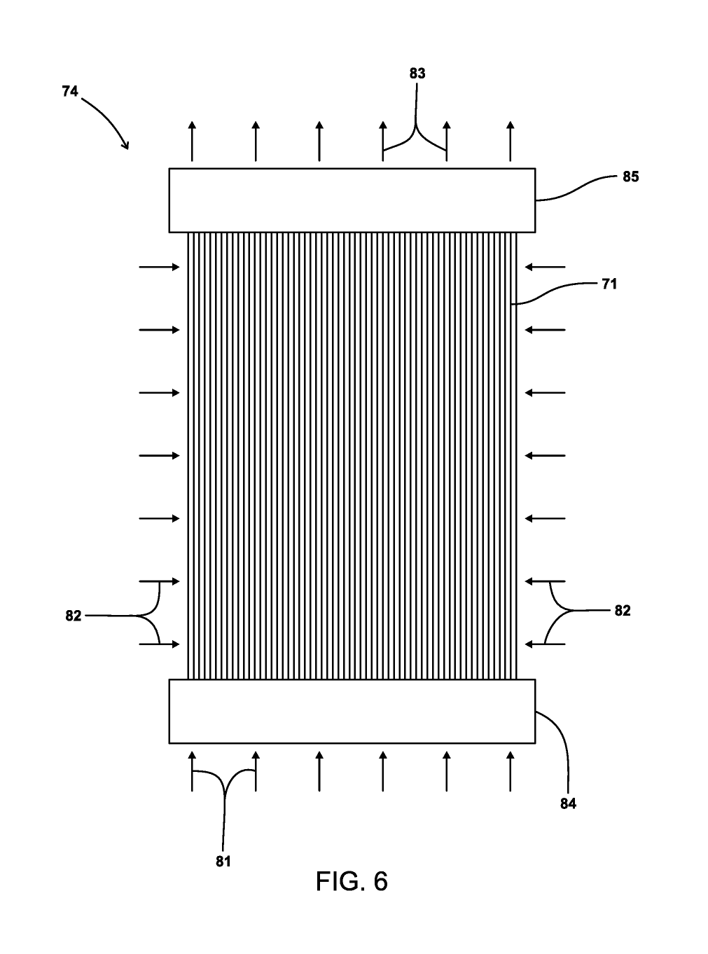

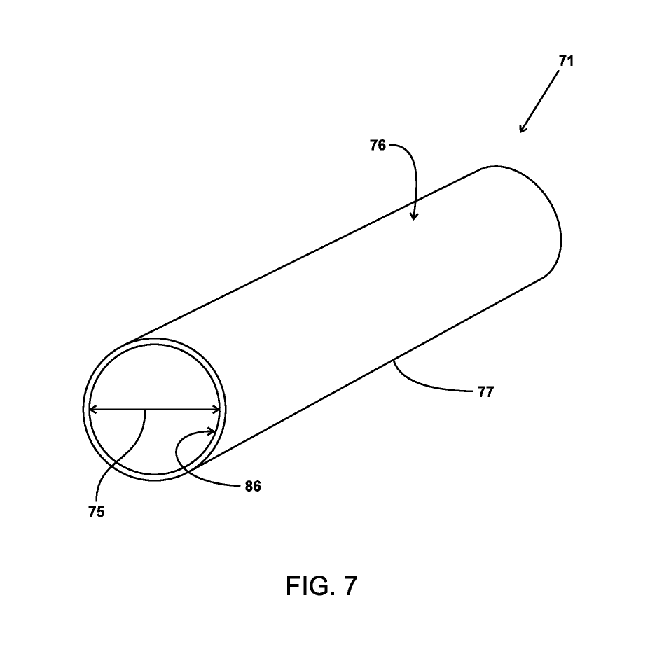

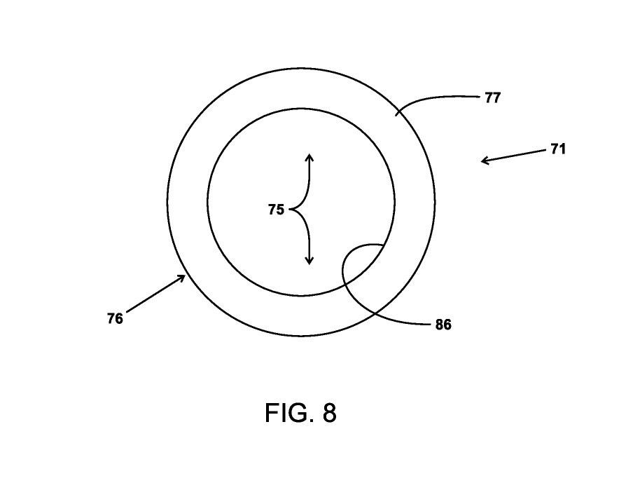

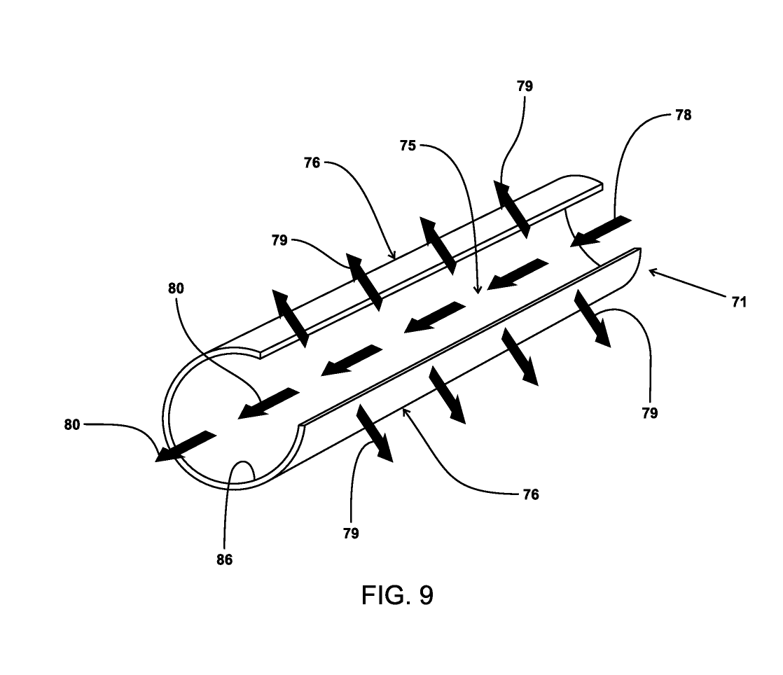

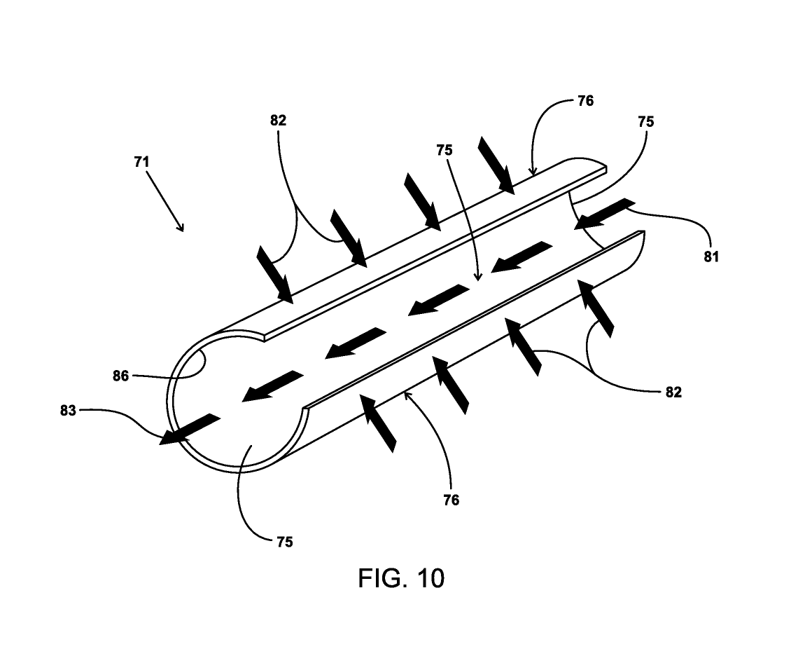

FIGS. 4-10 show in more detail the construction of bundles 74 contained in the membrane filtration treatment unit of the present invention. FIGS. 4-10 illustrate filtration and backwash at modules 144, 145 and at each hollow fiber ceramic membrane 71. FIG. 4 shows a bundle 74 of multiple hollow ceramic fibers 71, each such bundle 74 occupying a module or spool piece 66 or 67. There are six (6) modules 66, 67 in FIG. 2 and twenty-four (24) modules 66, 67 in FIG. 3. Wastewater flows through each bundle 74 of fibers 71 and through channel 75 of each individual hollow fiber ceramic membrane 71. Arrows 78-80 in FIG. 5 show fluid flow during filtration. Arrows 78 represent the effluent to be cleaned as it enters a bundle 74 of hollow fiber ceramic membranes 71. Arrows 79 represent permeate water that has passed through walls 77 of each hollow fiber ceramic membrane 71. Arrows 80 represent the retentate stream that is preferably discharged from the bundle 74. FIG. 6 shows fluid flow during backwash. In FIG. 6, arrows 81 represent a fluid stream (such as permeate water) used to backwash. Arrows 82 represent fluid such as permeate that flows through the walls 77 of the membranes 71. Arrows 83 represent a discharge of retentate from bundle 74 during backwash. Notice in FIG. 6 that the backwash fluid (e.g., permeate water) flows through bore or channel 75 in addition to through wall 77. FIGS. 7 and 8 show a single hollow fiber ceramic member 71. A bundle 74 as seen in FIGS. 4-6 would have about 200-1500 of such hollow fiber ceramic membranes 71 bundled into a cylinder shape. FIG. 9 also shows a single such membrane 71 during filtration. FIG. 10 shows a single such membrane 71 in backwash.

There can be between about two hundred and fifteen hundred (200-1500) hollow fiber ceramic membranes 71 in each module 15, 20, 144, 145. These membranes 71 are preferably bundled together to provide an overall cylindrically shaped bundle 74 of membranes 71 that are held in the cylindrically shaped bundle shape with end bands or end caps 84, 85. Flow of waste 112 preferably enters each module (and thus each hollow fiber ceramic membrane 71) at one end 84, discharging at the other end 85. In FIGS. 5 and 9, arrows 78 designate entry of wastewater into each membrane 71 while arrows 80 represent the discharge of retentate from each membrane 71 in module 15, 20, 144 or 145. Arrows 79 represent the inside to outside flow of permeate (cleaner) water from membranes 71 inner channel 75 to outer surface 76 of each membrane 71 (see FIGS. 5, 9).

Channels 75 of membranes 71 are preferably open ended so that wastewater 112 enters channel 75 at a first end 84 then exits channel 75 at a second end 85. Membrane 71 can have a generally cylindrically shaped wall 77 surrounding channel 75. Wall 77 has inner surface 86 with a separating layer of porous polymeric material or porous ceramic material.

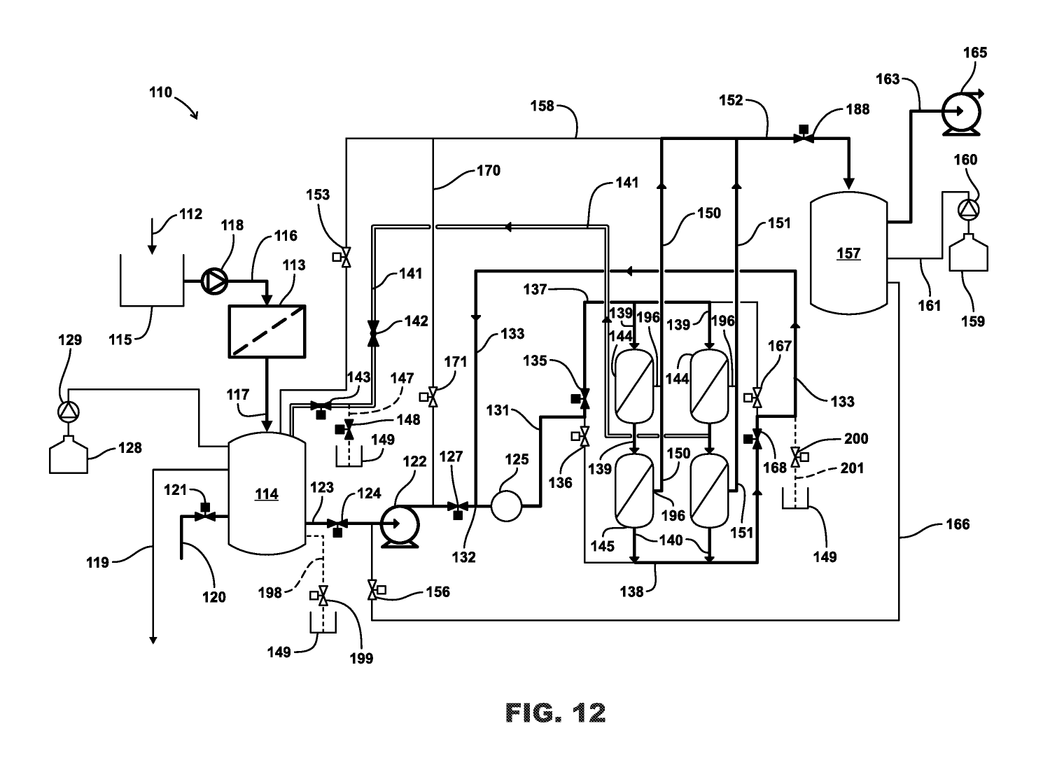

FIGS. 6 and 10 illustrate a backwash which occurs after the filtration of FIG. 12. Arrows 82 represent an outside to inside flow of fluid from outer surface 76 of each membrane 71 to the inside surface 86 and into the channel 75 as occurs during backwash. Simultaneously, flow through channel 75 is preferably longitudinally from one end 84 to the other end 85 as illustrated by arrows 81, 83 in FIGS. 6, 10. The flow longitudinally preferably carries away retentate that is preferably adhered to inside surface 86 during the FIG. 12 filtration.

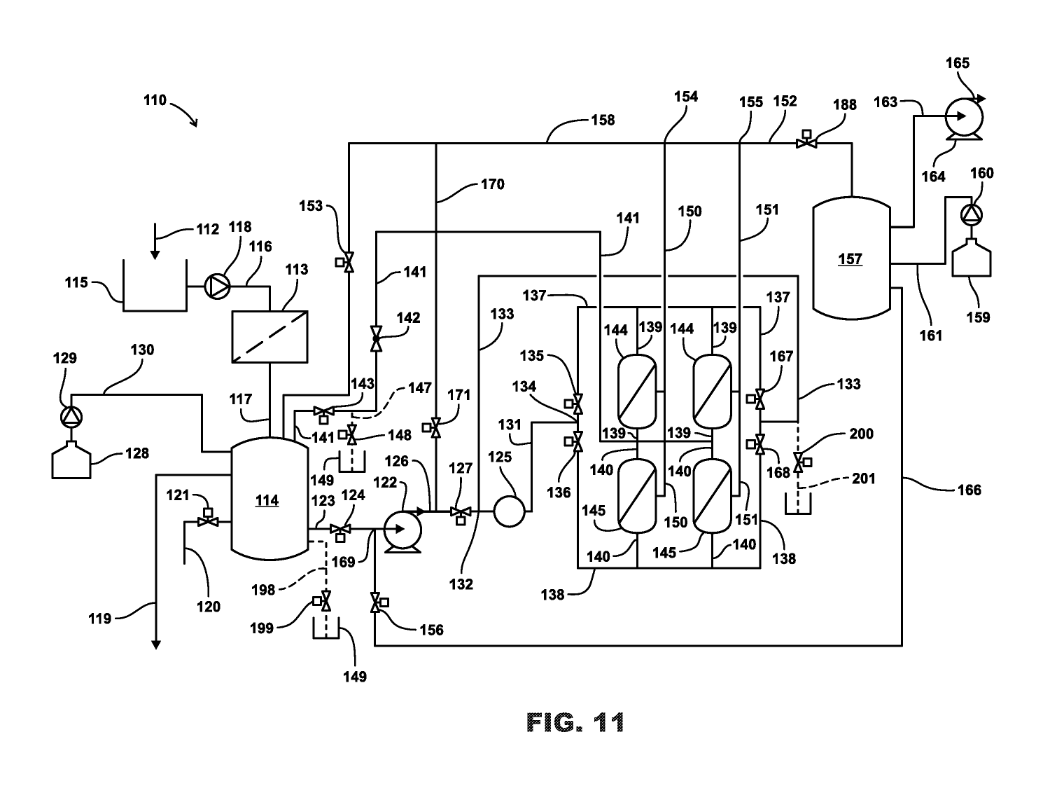

FIGS. 11 and 12 show membrane filtration treatment units 110 used for commercial and industrial applications. Apparatus 110 in FIGS. 11-12 has piping that routes an incoming wastewater stream 112 to pretreatment screen 113 (e.g., vibratory screen) and then feed tank 114. In FIGS. 11-12, wastewater stream 112 can be transmitted from commercial laundry 11 to an effluent sump 115 before cleaning at screen/pre-filter 113 to remove larger particles such as lint or fiber material. Flow line 116 has pump 118 for transfer of fluid from tank 115 to screen 113 and then via line 117 to tank 114.

Feed tank or vessel 114 receives flow from sump 115 and screen 113 via flow lines 116, 117. Feed tank 114 transmits the wastewater stream 112 to the various pump, valve and treatment module components that can be for example skid mounted on skid or base or frame 62 (see FIGS. 2-3). Apparatus 110 has a piping system that includes a left conduit 139 and a right conduit 140. One or more hollow fiber ceramic membranes modules 144-145 can be housed in a generally U-shaped pipe section that includes two spaced apart vertical sections connected by a one hundred eighty degree) (180°) elbow. Modules 144-145 are preferably in conduits 139, 140 but have annular space around each module 144, 145 for collecting permeate water or for introducing backwash water. Conduits 139, 140 can be a part of six (6) vertical sections of pipe each housing a stack of three filtration modules 144 or 145. Two of the vertical sections can connect at a 180 degree elbow. Flow outlets 196 can be provided on the conduits 139,140 and elbow sections for permeate discharge and for retentate discharge. The permeate discharge flow outlets preferably receive backwash water during a backwash cycle. Each module 144-145 has a plurality of hollow ceramic fibers membranes 71. FIGS. 7-10 show such modules 144-145 and ceramic fiber membranes 71 in more detail.

The method of the present invention intermittently alternates fluid to a left hand side membrane loop conduit 139 then to the right hand side membrane loop conduit 140 via a 180 degree elbow. In between the left hand conduit filtration and the right hand conduit filtration is preferably a backwash cycle (see FIGS. 11, 12).

In one embodiment, the method includes heating the wastewater stream or effluent held in a feed tank 114 by way of a valve 121 (e.g., actuated control valve) and heater or steam injector line 120. Feed tank 114 can have a level control and overflow line 119. Steam or heater 120 may be operable to heat the wastewater or effluent in tank 114 to about 40 degrees centigrade or more. The heater 120 may be operable to heat the effluent to about 50 degrees centigrade or more. The heater 120 may be operable to heat the effluent to within a temperature range of about 50 to 80 degrees centigrade. The heater 120 may be operable to heat the effluent to about 60 degrees centigrade or more.

Once effluent 112 is preferably at a temperature of between about 50 and 80 degrees centigrade, the feed pump 122 is preferably enabled to a set point of between about 1-10 bar. Pump 122 receives flow from feed tank 114 via line 123 with valve 124. Pump 122 pumps to line 126 which is preferably an inlet conduit. From pump 122, flow goes to pump 125 (circulation pump) preferably via valve 127, and through valve 135 or 136 to the filtration modules 144 or 145. There are two (left and right) conduits 139, 140 each with multiple modules 144 or 145. Each module 144 or 145 is preferably contained in a stainless steel conduit or pipe 139 or 140 that enables filtered water to be collected after filtration through each hollow fiber ceramic membrane 71. The stainless steel conduit or pipe 139, 140 also contains fluid used for backwash in an out to in flow path.

There are preferably eighteen (18) modules including nine (9) left side modules 144 and nine (9) right side modules 145. The membrane modules 44, 45 can be individual or stacked forming a vertical or horizontal column. A circulation loop conduit (lines 137, 139, 140, 138) feeds the hollow fiber ceramic membrane modules 144, 145. During this method, “crossflow” occurs at each hollow fiber membrane 71 in the module 144 or 145, separating contaminated effluent that is preferably channeled to both the retentate conduit 141 and clean fluid conduits 150, 151, 152 known as permeate to the permeate clean tank 157.

Pump 122 supplies the wastewater 112 to circulation pump 125 via line 126 and valve 127. Tee fitting 132 connects line 126 and 133. Pump 125 discharges into line 131 and tee fitting 134 which provides selective transmission of fluid to either line 137 or 138 depending upon the open or closed state of valves 135, 136.

A circulation is preferably enabled during filtration by transmitting the wastewater 112 in a first direction through lines 139, 140 and modules 144, 145 and back to circulation pump 125 via flow line 133. FIG. 12 demonstrates such a “left conduit” filtration. Retentate line 141 connects to lines 139, 140 and continuously removes retentate that is preferably filtered by the modules 144, 145.

Retentate line 141 enables transmission of retentate to feed tank 114 via valves 142, 143. Part of the retentate stream of line 141 can be discarded to drain or sewer 149 via drain line 147 and valve 148. Permeate flow lines 150, 151, 152 transmit cleaned fluid from modules 144, 145 to permeate tank 157. Line 152 has valve 188. Permeate lines 150, 151 connect to line 152 at tee fittings 154, 155. Permeate tank 157 can be used for backwashing. Line 166 is preferably a backwash flow line having valve 156. Line 166 joins line 123 at tee fitting 169. Line 161 enables pH adjustment of permeate water in tank 157. pH adjustment device 159 enables a desired pH adjustment via line 161 and pump 160. Clean water can be transmitted to commercial laundry 11 via flow line 163, pump 164 and discharge line 165. Water can optionally be discharged from feed tank 114 via flow line 198 and valve 199 to sewer 149.

FIG. 12 is a schematic diagram of filtration with pumping of effluent into the left conduits 139. Valve 171 of backwash line 170 is closed. Valve 136 is closed. Valve 167 is closed. Valve 156 is closed. Recirculating flow is from pumps 122 and 125 to line 131, then to line 137 via open valve 135, then to left inlet conduits 139 and then through the modules 144, 145 to lines 140 and 138. Valve 168 is open enabling recirculation to circulation pump 125 via line 133 to tee fitting 132. The filtration of FIG. 12 can operate for a time period of about 5 or more minutes.

The present invention can optionally use cleaning in place. Cleaning in place can include the external injection from clean in place dosing tank 128 and pump 129 and via line 130 into the commercial or industrial laundry effluent treatment device of an alkali or acidic solution into the feed tank 114, mixed with clean water being city or permeate water. Clean in place is operable to preserve, maintain or restore the clean fluid permeation flow through the ceramic hollow fiber wall 77, being either individual or multiple hollow fiber membranes 71, which includes nominal 220 to 1500 individual ceramic hollow fibers 71 made of a substrate such as an aluminium oxide (Al₂O₃) substrate material. Selective pore sizes of the aluminium oxide substrate material (Al₂O₃) can be about 50 to 1400 nanometers, also but not limited to selective pore sizes of the aluminium oxide substrate material (Al₂O₃) being nominal 50 to 1400 nanometers, including nominal 1 to 100 nanometers ceramic or porous polymeric coating or multiple separate porous ceramic or polymeric coatings, acting as a separation layer attached to the membrane fiber wall at inner surface 86. In one embodiment, clean in place device 128 transmits a selected cleaning chemical from the dosing device 128 and pump 129 to tank 114. Valves 124, 127, 135, 136, 142, 143, 156, 167, 168 and 188 are opened. Valve 200 is opened to drain all fluid via line 201 to sewer 149. Line 198 and valve 199 can also be used to drain all fluid. Clean in place cycle can have a duration of about 60-1200 seconds. In one embodiment, valves 124, 127, 135, 142, 143, 153 and 168 are preferably open. Flow to valve 153 is via line 158.

The following is a list of parts and materials suitable for use in the present invention:

PARTS LIST:

| PART NUMBER | DESCRIPTION |
|---|---|
| 10 | laundry waste water treatment system |
| 11 | tunnel washer/commercial washer |
| 12 | feed tank |
| 13 | flow line |
| 14 | flow line |
| 15 | treatment module/unit |
| 16 | flow line |
| 17 | flow line |
| 18 | retentate tank |
| 19 | flow line |
| 20 | retentate treatment module/unit |
| 21 | flow line |
| 22 | tee fitting |
| 23 | permeate tank |
| 24 | flow line |
| 25 | dosing/mixing unit/system |
| 26 | arrow |
| 27 | solid waste |
| 28 | disposal facility |
| 29 | arrow |
| 40 | filtration device/skid |
| 41 | feed pipe |
| 42 | recirculation pump |
| 43 | butterfly valve |
| 44 | butterfly valve |
| 45 | butterfly valve |
| 46 | butterfly valve |
| 47 | butterfly valve |
| 48 | butterfly valve |
| 49 | butterfly valve |
| 50 | butterfly valve |
| 51 | butterfly valve |
| 52 | butterfly valve |
| 53 | butterfly valve |
| 54 | butterfly valve |
| 55 | butterfly valve |
| 56 | pressure transmitter |
| 57 | flow meter |
| 58 | flow meter |
| 59 | turbidity meter |
| 60 | flow meter |
| 61 | pressure transmitter |
| 62 | globe valve |
| 63 | pressure transmitter |
| 64 | control panel |
| 65 | future filter expansion |
| 66 | stacked filters/modules/spool piece |
| 67 | stacked filters/modules/spool piece |
| 70 | filtration device/skid |
| 71 | fiber/member/membrane/filter/hollow |
| | fiber ceramic membrane |
| 72 | elbow fitting |
| 73 | elbow fitting |
| 74 | bundle |
| 75 | channel/inside channel |
| 76 | outside surface |
| 77 | wall |
| 78 | arrow |
| 79 | arrow |
| 80 | arrow |
| 81 | arrow |
| 82 | arrow |
| 83 | arrow |
| 84 | end cap |
| 85 | end cap |
| 86 | inner surface |
| 110 | wastewater treatment apparatus |
| 112 | commercial/industrial laundry |
| | effluent/wastewater |
| 113 | pretreatment screen/filter/vibrating |
| | screen |
| 114 | feed tank/vessel |
| 115 | sump/effluent sump |
| 116 | flow line |
| 117 | flow line |
| 118 | pump |
| 119 | overflow line |
| 120 | steam/steam inlet/steam flow line/heater |
| 121 | valve |
| 122 | feed pump |
| 123 | flow line |
| 124 | valve |
| 125 | circulation pump |
| 126 | flow line |
| 127 | valve |
| 128 | clean in place dosing device |
| 129 | pump |
| 130 | flow line |
| 131 | flow line |
| 132 | tee fitting |
| 133 | flow line |
| 134 | tee fitting |
| 135 | valve |
| 136 | valve |
| 137 | flow line |
| 138 | flow line |
| 139 | left conduit/membrane loop conduit |
| 140 | right conduit/membrane loop conduit |
| 141 | retentate line |
| 142 | valve |
| 143 | valve |
| 144 | module of ceramic hollow fiber |
| | membranes (left) |
| 145 | module of ceramic hollow fiber |
| | membranes (right) |
| 147 | drain line |
| 148 | valve |
| 149 | sewer |
| 150 | permeate flow line |
| 151 | permeate flow line |
| 152 | permeate flow line |
| 153 | valve |
| 154 | tee fitting |
| 155 | tee fitting |
| 156 | valve |
| 157 | clean water tank/permeate tank |
| 158 | flow line |
| 159 | pH adjustment device |
| 160 | pump |
| 161 | flow line |
| 163 | flow line |
| 164 | permeate pump |
| 165 | flow line/discharge flow line |
| 166 | backwash flow line |
| 167 | valve |
| 168 | valve |
| 169 | tee fitting |
| 170 | flow line |
| 171 | valve |
| 188 | valve |
| 196 | flow outlet |
| 198 | line |
| 199 | valve |
| 200 | valve |
| 201 | flow line |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of treating a commercial laundry waste stream, comprising the steps of:
a) discharging the commercial laundry waste stream from one or more commercial washing machines, wherein the waste stream includes one or more of suspended solids, dissolved solids, and CBOD (chemical biological oxygen demand);
b) transmitting the waste stream to a first treatment unit that has a membrane filter that filters particles of between about 20 and 200 nanometers (nm);
c) separating the waste stream of step “b” into a permeate stream and a retentate component, wherein the retentate component is smaller than the permeate stream;
d) transmitting the retentate component of step “c” to a second treatment unit that filters particles of between about three and twenty (3-20) nanometers;
e) transmitting the permeate stream of step “c” to a permeate holding vessel; and
f) after step “d” mixing the retentate component in a mixing vessel with a polymer, or polymer blend to form a solid waste.

2. The method of claim 1 wherein in step “d” a second permeate flow stream discharges from the second treatment unit.

3. The method of claim 1 wherein in step “d” the retentate component is reduced to between about 0.1 and 0.5 liters per kilogram.

4. The method of claim 1 wherein the filtered permeate stream has a chemical biological oxygen demand (BOD) that is reduced by over seventy percent (70%) in steps “a” through “f”.

5. The method of claim 1 wherein the filtered permeate stream has a chemical biological oxygen demand (BOD) that is reduced by about ninety percent (90%) in steps “a” through “f”.

6. The method of claim 1 wherein the filtered permeate stream has total suspended solids (TSS) that was reduced by over seventy percent (70%) in steps “a” through “f”.

7. The method of claim 1 wherein the filtered permeate stream has total suspended solids (TSS) that was reduced by about ninety-six percent (96%) in steps “a” through “f”.

8. The method of claim 1 wherein the filtered permeate stream has turbidity that was reduced by over seventy percent (70%) in steps “a” through “f”.

9. The method of claim 1 wherein the filtered permeate stream has turbidity that was reduced by about ninety-eight percent (98%) in steps “a” through “f”.

10. The method of claim 1 wherein the filtered permeate stream has a non-detectable level of E-Coli after steps “a” through “f”.

11. The method of claim 1 wherein one of said treatment units includes a bundle of at least 200 hollow fiber ceramic membranes.

12. The method of claim 1, wherein the polymer, polymer blend can be composed of mixtures of superabsorbent polyacylate polymers with inorganic clays.

13. The method of claim 1, wherein the polymer, polymer blend can be bentonite clay.

14. The method of claim 12, wherein the superabsorbent polyacrylate - clay mixtures can contain about 30% to 80% superabsorbent polyacrylate.

15. The method of claim 1 wherein in step “f” the retentate component includes highly concentrated biological oxygen demand (B.O.D.) of between about 1938 and 13,900 mg/L, Chemical oxygen demand (COD) of between about 2,805 and 17,595, total dissolved solids (T.D.S.) of between about 3250-4550 mg/L and Total suspended solids (T.S.S.) of between about 450-3200 mg/L.

16. The method of claim 1, wherein the membrane filter can be include multiple pairs of risers, each said pair of risers including a first and second elbows.

17. A method of treating a commercial laundry waste stream, comprising the steps of:
a) discharging the commercial laundry waste stream from a commercial washing machine, wherein the waste stream includes one or more of suspended solids, dissolved solids, and CBOD (chemical biological oxygen demand);
b) transmitting the commercial laundry waste stream wherein the waste stream is treated with a filter to remove particles of between about twenty and two hundred nonometers;
c) separating the waste stream of step “b” into a permeate stream and a retentate component;
d) transmitting the retentate component of step “c” to a second treatment unit that removes particles of a second size that is between about three and twenty (3-20) nanometers;
e) transmitting the permeate stream of step “c” to a permeate holding vessel; and
f) after step “d”, solidifying the retentate component by combining the retentate component with a polymer.

18. The method of claim 17 wherein one of said treatment units includes a bundle of at least 200 hollow fiber ceramic membranes.

19. The method of claim 18 wherein each hollow fiber ceramic filter is tubular, having a central longitudinal bore.

20. The method of claim 17 wherein in step “f” the retentate component includes highly concentrated biological oxygen demand (B.O.D.) of between about 1938 and 13,900 mg/L, Chemical oxygen demand (COD) of between about 2,805 and 17,595, total dissolved solids (T.D.S.) of between about 3250-4550 mg/L and Total suspended solids (T.S.S.) of between about 450-3200 mg/L.

21. The method of claim 17 wherein the permeate stream of steps “c” and “e” is comprised of non-detectable levels of E-Coli and turbidity of less than one (1) nephelometric turbidity units (N.T.U.).

22. The method of claim 18 wherein there are multiple modules, each module having a bundle of hollow fiber ceramic membrane.

23. The method of claim 17 wherein both of said treatment units includes a bundle of at least 200 hollow fiber ceramic membranes.

24. The method of claim 18 wherein there are a plurality of said bundles.

25. The method of claim 24 wherein at least some of said bundles are vertically stacked one upon the other and wherein the waste stream flows from a lower of said bundles to an upper of said bundles.

26. The method of claim 17, wherein the polymer, polymer blend can be composed of mixtures of superabsorbent polyacylate polymers with inorganic clays.

27. The method of claim 17, wherein the polymer, polymer blend can be bentonite clay.

28. The method of claim 26, wherein the superabsorbent polyacrylate - clay mixtures can contain about 30% to 80% superabsorbent polyacrylate.

29. The method of claim 18, wherein the ceramic membranes can include multiple pairs of risers, each said pair of risers connected with one or more elbow fittings.

30. (canceled)
